(19) United States
(12) Patent Application Publication
(10) Pub. No.: US 2025/0087876 A1
(43) Pub. Date: Mar. 13, 2025

(54) MULTI-SENSOR TILT MEASUREMENT FOR ANTENNA MONITORING DEVICES

(71) Applicant: Viavi Solutions Inc., Chandler, AZ (US)

(72) Inventors: Raleigh B. STELLE, IV, Indiannapolis, IN (US); Thomas SEVILLA, Miramar, FL (US)

(73) Assignee: Viavi Solutions Inc., Chandler, AZ (US)

(21) Appl. No.: 18/464,586

(22) Filed: Sep. 11, 2023

(51) Int. Cl. H01Q 3/08; G01P 15/18

(52) U.S. Cl. CPC H01Q 3/08; G01P 15/18

(57) ABSTRACT

Multiple and diverse sensors may be used for antenna monitoring devices. MEMS sensors, electrolytic tilt sensors, thermal mass accelerometers, and/or any other types of tilt sensors may be used. Out of the multiple, diverse tilt sensors, a first sensor (or a first set of sensors) may be used for a first measurement and a second sensor (or a second set of sensors) may be used for augmenting or validating the first measurement. As another example, the second sensor (or the second set of sensors) may be used for correcting errors in the first measurement.

### BACKGROUND

Modern communication systems rely heavily on wireless signals transmitted and received by antennas. On the transmit side, antennas receive fluctuating electrical currents through wires from connected circuitry and generate wireless signals as electromagnetic fields corresponding to the fluctuating electrical currents. On the receive side, antennas convert electromagnetic fields of received wireless signals to electrical currents carried through wires to the connected circuitry. Because of directional oscillation of electrical and magnetic fields, wireless signaling through the transmittal and receipt of electromagnetic fields is inherently directional—heavily influenced by the location of the signal source, multipathing, beamforming, and or other aspects associated with electromagnetic fields and electromagnetic radiation. Therefore, for an optimal bandwidth and signal strength, antennas—both on the transmit and receive sides—may require precise alignments and tuning with respect to each other.

Antenna monitoring devices are generally used for supervision of physical antenna attributes such as azimuth, tilt and or roll, which can be used to aid in alignment or tuning of antennas. An antenna monitoring device is generally an electronic device that is mounted (typically permanently) on the antenna or a structure supporting the antenna. Within the antenna monitoring device, electronic and magnetic components measure antenna tuning parameters and or a directional alignment of the antenna in terms of antenna roll, tilt, and/or azimuth. Feedback provided by the antenna monitoring device, e.g., through an interface, may be used to tune the antenna and or adjust the alignment of the antenna to a desired roll, tilt, and/or azimuth.

Typically, micro electromechanical system (MEMS) sensors are used to measure the roll and tilt of the antenna monitoring devices (and vicariously the antenna itself) by measuring the gravity vector. MEMS sensors are typically based on microelectronic chips that have mechanical portions such as springs changed by the gravity vector. The change in the mechanical portions is captured electronically, e.g., a mechanical movement can be electronically captured as a change in capacitance and the change in capacitance can be processed to determine the orientation of a sensor vis-à-vis the gravity vector.

MEMS sensors, however, are prone to drift and failure. For example, MEMS sensors experience temperature drift because temperature affects the mechanical portions of the sensors—excess heat may expand the spring and excess cold may contract the spring. The drift may further be caused by changes to the mechanical structure over the course of time. For example, the MEMS sensors—deployed in the external environment—are exposed to extreme weather conditions that may affect the mechanical structure of the sensors.

All of these and other factors may introduce noise and errors in the MEMS sensors, which is undesirable. As such, a significant improvement in deploying MEMS sensors in antenna monitoring devices is desired.

### SUMMARY

Embodiments disclosed herein solve the aforementioned technical problems and may provide other solutions as well. In one or more embodiments, multiple and diverse sensors may be used for the antenna monitoring devices. In addition to MEMS sensors, electrolytic tilt sensors, thermal mass accelerometers, and/or any other types of tilt sensors may be added. Out of the multiple, diverse tilt sensors, a first sensor (or a first set of sensors) may be used for a first measurement and a second sensor (or a second set of sensors) may be used for augmenting or validating the first measurement. As another example, the second sensor (or the second set of sensors) may be used for correcting errors in the first measurement.

In one or more embodiments, a monitoring device configured to monitor an alignment of an antenna is provided. The antenna monitoring device may comprise a first sensor configured to measure an antenna alignment parameter using a first type of measurement mechanism. The antenna monitoring device may also comprise a second sensor configured to measure the antenna alignment parameter using a second type measurement mechanism. The antenna monitoring device may further comprise a processor configured to determine the antenna alignment parameter based on the measurement from the first sensor and the measurement from the second sensor.

In one or more embodiments, a method of monitoring an alignment of an antenna is provided. The method may comprise measuring, by a first sensor of an antenna monitoring device, an antenna alignment parameter using a first type of measurement mechanism. The method may also include measuring, by a second sensor of the antenna monitoring device, the antenna alignment parameter using a second type of measurement mechanism. The method may further comprise determining, by a processor of the antenna monitoring device, the antenna alignment parameter based on the measurement from the first sensor and the measurement from the second sensor.

It should be understood that this summary just provides example embodiments for a quick introduction of the disclosure and should not be considered limiting.

### BRIEF DESCRIPTION OF THE DRAWINGS

FIG. 1 shows an example environment for antenna monitoring, based on the principles disclosed herein.

FIG. 2 shows an architecture diagram of an antenna monitoring device based on the principles disclosed herein.

FIG. 3 shows a flow diagram of an example method of measuring tilt or roll of an antenna monitoring device based on the principles disclosed herein.

FIG. 4 shows a flow diagram of an example method of measuring tilt or roll of an antenna monitoring device based on the principles disclosed herein.

FIG. 5 shows a graph illustrating an improvement in tilt and roll measurement by using multiple sensors based on the principles disclosed herein.

It should be understood that the drawings are just for illustrating the principles disclosed herein and should not be considered limiting.

### DETAILED DESCRIPTION OF SEVERAL EMBODIMENTS

As opposed to the conventional use of single sensors, antenna monitoring devices based on the principles disclosed herein may use multiple, diverse sensors for measuring the roll or tilt of an antenna. The diverse sensors may use different mechanisms to measure the roll or tilt. For example, the mechanisms may include detecting, among other things, a change in capacitance due to a change in orientation of a mass such as in a micro electromechanical system (MEMS) sensor, change in a level of a fluid vis-à-vis a housing as in an electrolytic tilt sensor, change in temperature distribution based on an orientation of a thermal mass as in a thermal mass accelerometer, and/or the like. Limitations of one type of mechanism may therefore be overcome by employing another type of mechanism. For example, a limited measurement range of an electrolytic tilt sensor can be augmented by a larger measurement range of a MEMS sensor. As another example, vibration noises in the MEMS sensor can be corrected using the thermal mass accelerometer.

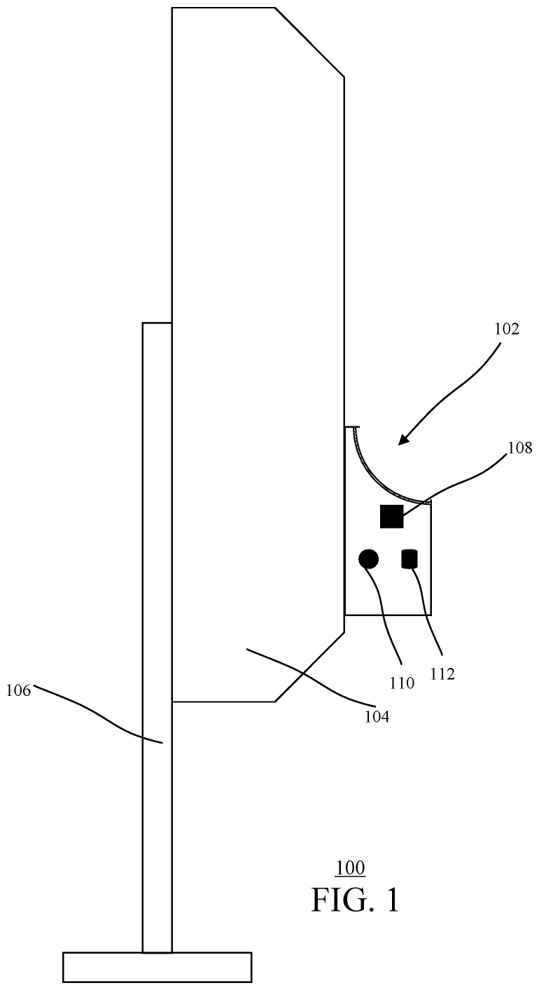

FIG. 1 shows an example environment 100 for antenna monitoring, based on the principles disclosed herein. The example environment 100 includes an antenna 104, which may be disposed on a support structure 106. The shown support structure 106 is just one example, and the antenna 104 may be located on any type of suitable support structure such as e.g., an antenna tower, rooftop, treetop, building wall, vehicle top, satellite, and/or the like. Furthermore, the antenna 104 can be any type of antenna, including a dome antenna, a sector antenna, a microwave antenna, an omnidirectional antenna, a loop antenna, a multibeam antenna, a Yagi-type antenna, and/or any type of antenna that may have to have a consistent alignment for optimal performance. In one or more embodiments, the antenna 104 may be a part of a cellular telephony network such as 5^{th} generation mobile network (5G). More particularly, the antenna 104 may be a part of a base station of the cellular telephony network.

An antenna monitoring device 102 may be used for monitoring the antenna 104. For example, the antenna monitoring device 102 may output alignment information such as roll, tilt, and or azimuth information. Using the alignment information, a user may monitor the antenna 104 to determine whether it has maintained a desired roll, tilt, and/or azimuth. For example, the antenna monitoring device 102 may upload the monitored parameters (e.g., roll, tilt, and/or azimuth) to a remote device (e.g., a cloud server), which may be accessed to determine whether the antenna 104 has maintained its desired alignment. As used herein, antenna monitoring parameters may include antenna alignment parameters (e.g., roll, tilt, and/or azimuth). The antenna alignment parameters may also be referred to as antenna tuning parameters.

To measure the roll and tilt, the antenna monitoring device 102 may use multiple and diverse types of sensors in accordance with the disclosed principles. As shown, some non-limiting example sensors may include a MEMS sensor 108, electrolytic tilt sensor 110, and thermal mass accelerometer 112. Because these sensors are provided as non-limiting examples, any other types of electrical, mechanical, electromechanical, thermal, chemical, and/or electrochemical sensors should be considered within the scope of this disclosure. In one or more embodiments, a same type of sensor may be used at multiple locations of the antenna monitoring device 102. The sensors 108, 110, 112 may be used in various combination to measure the roll and tilt, and augment, validate, and/or correct the measured roll and tilt.

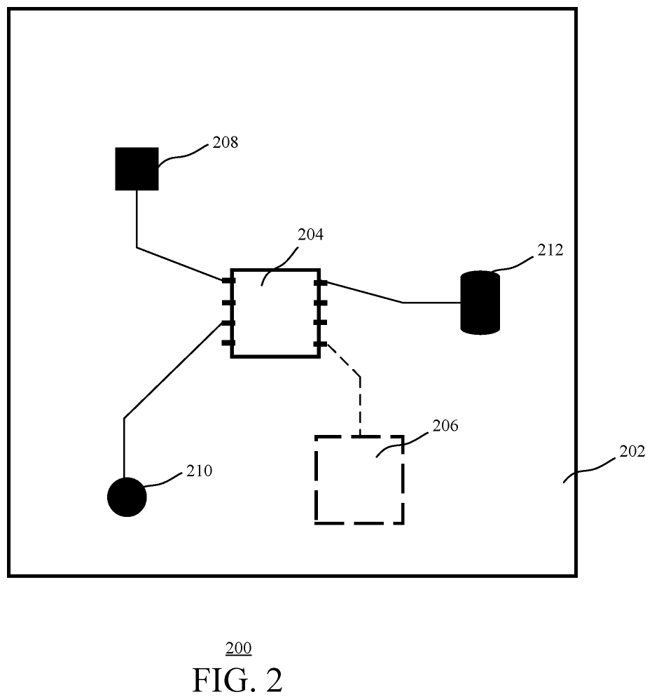

FIG. 2 shows an architecture diagram 200 of an antenna monitoring device based on the principles disclosed herein. It should be understood that the architecture diagram 200 is for illustration purposes and the shown and described embodiment should not be considered limiting. Other types of architecture including additional, alternative, or fewer number of components should be considered within the scope of this disclosure.

In one or more embodiments, the components may be organized and interconnected using a printed circuit board (PCB) 202. The PCB 202 may comprise a microprocessor 204, which may include any kind of transistor-based processing device such as processor, controller, and/or the like. In the illustrated embodiment, a MEMS sensor 208, electrolytic tilt sensor 210, and the thermal mass accelerometer 212 are connected to the processor 204. There may be additional components 206—such as additional sensors, electronic components, etc.—also connected to the processor 204. The processor 204 may control the sensors 208, 210, 212 and the overall operation of the antenna monitoring device.

The operation of the MEMS sensor 208 is known in the art, and therefore will not be described in detailed herein. At a high level, a MEMS sensor 208 translates a mechanical effect to an electronic signal, which be used by the processor 204 to determine the tilt or roll of the antenna alignment device. For example, a movable spring can be disposed in between other components, and when the spring moves in relation to the other components, e.g., due to the gravity vector, a capacitance between the spring and the other components changes. The changed capacitance can be processed electronically (e.g., within the sensor 208 itself and/or by the processor 204) to determine the roll or the tilt of the antenna monitoring device in relation to the earth's surface.

Similarly, the operation of electrolytic tilt sensor 210 is known in the art and will not be described in detail herein. At a high level, the electrolytic tilt sensor 210 is filled with an electrolytic fluid, which maintains its level based on earth's gravity. When the electrolytic tilt sensor 210 tilts, the electrolytic fluid level is maintained but it will have a different orientation vis-à-vis the housing of the sensor. This change in orientation may be used to determine the tilt or roll of the antenna monitoring device.

Thermal mass accelerometer 212, also known in the art, is based on temperature asymmetry due to roll or tilt. A central heating beam and a symmetric thermometer array is disposed within a cavity. If there is no roll or tilt, the temperature distribution is symmetric. When there is a roll or tilt, the temperature distribution becomes asymmetric and can be used to measure the roll or the tilt.

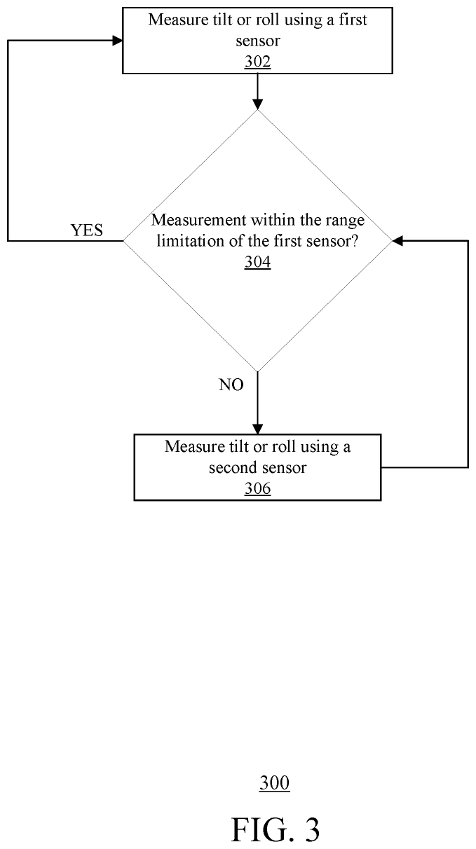

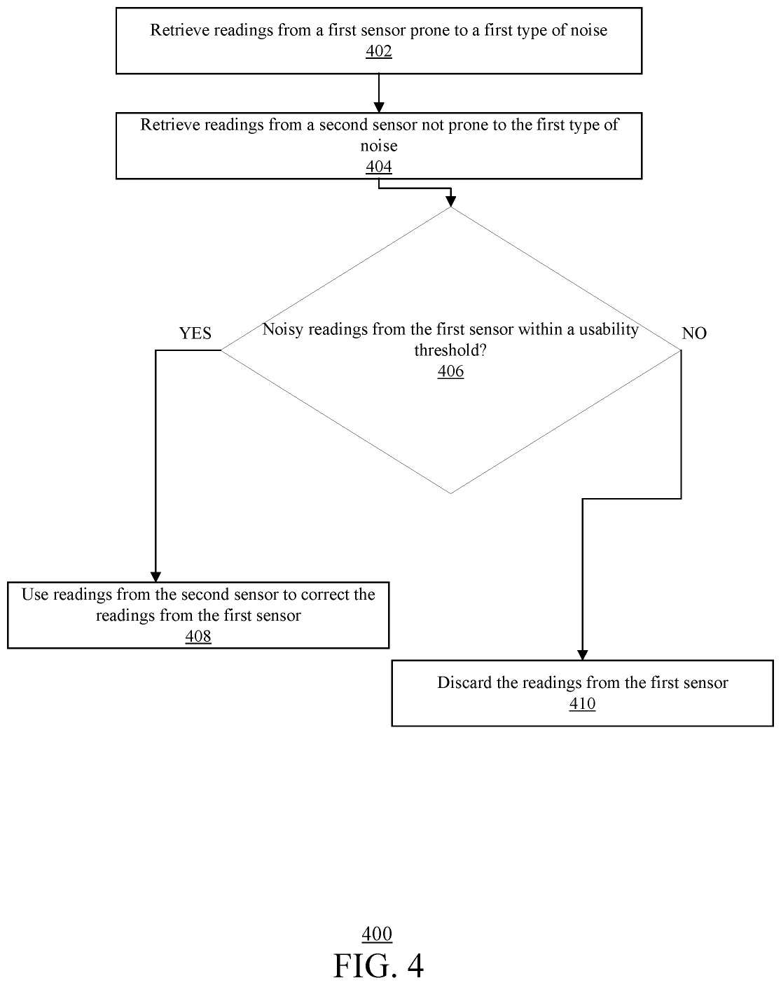

The processor 204 may use measurements from the MEMS sensor 208, electrolytic tilt sensor 210, and thermal mass accelerometers 212 for a more accurate and reliable determination of roll and tilt of the antenna monitoring device. Such accuracy and reliability are significantly better than conventional single MEMS sensor-based measurement systems. Some non-limiting example use cases of deploying and using multiple, diverse sensors are described below in reference to FIGS. 3 and 4.

FIG. 3 shows a flow diagram of an example method 300 of measuring tilt or roll of an antenna monitoring device based on the principles disclosed herein. The method 300 may be used for augmenting a measurement range limitation of a first sensor by deploying a second sensor. It should be understood that steps of the method 300 shown in FIG. 3 and described herein are merely examples and should not be considered limiting. Methods with additional, alternate, or fewer number of steps should be considered within the scope of this disclosure. Although the method 300 has been described in terms of first second sensors for the sake of brevity, the embodiments are equally applicable to multiple sets of sensors (i.e., greater than 2 sensors). The method 300 may be performed by a processor (e.g., processor 204 shown in FIG. 2).

The method 300 begins at step 302, where tilt or roll is measured using a first sensor. The first sensor may comprise an electrolytic tilt sensor, which may have a range limitation. For example, the range limitation may be +/−20 degrees. That is, the electrolytic tilt sensor's reading may be accurate between −20 degrees to +20 degrees from the desired roll or tilt.

At step 304, a check is made to determine whether the measurement is within the range limitation (e.g., +/−20 degrees) of the first sensor. If the measurement is within the range, the operation may revert back to step 302 to take another measurement. Therefore, a periodic check is made using steps 302 and 304 to determine whether the first sensor is making the measurements within its known range limitation.

If it is determined in step 304 that the measurement is not within the range limitation of the first sensor, step 306 may be executed to measure tilt and roll using a second sensor. The second sensor may comprise a MEMS sensor that may provide a measurement of tilt or roll to a full range of +/−360 degrees. The MEMS sensor allows the system to continue to measure tilt and roll with limited accuracy outside of the nominal range of the first sensor.

Therefore, the first sensor with more accuracy but a smaller range may be used for regular measurement (e.g., by running a loop of steps 302 and 304). That is, measurements from the first sensor are used until the system is just short of the first sensor's limits. When the first sensor approaches or exceeds its limits, the second sensor may be used to determine the roll or the tilt. The second sensor measurements may first be used to validate the measurements of the first sensor because the near-limit measurements from the first sensor may inherently be untrustworthy. Such validation may indicate whether the first sensor has exceeded its limit. Additionally, the measurements from the second sensor may be used in place of the measurements of the first sensor when the first sensor is outside its limit. The measurements from the second sensor may be used in the loop of steps 304 and 306 until it is determined the tilt or roll reverts to measurement limit of the first sensor.

The above is just an example operation of using multiple, diverse sensors and these sensors can be used for other types of operations as well. For example, an electrolytic tilt sensor may generate measurements that appear to be within a valid range. A MEMS sensor can be used to perform independent measurements to validate that the measurements performed by the electrolytic tilt sensor are in fact within the valid range. In case of catastrophic events (antenna bracket failure, extreme high wind events such as hurricanes and tornadoes, and/or the like), the MEMS sensor may be used which may provide a reasonably good measurement,

FIG. 4 shows a flow diagram of an example method 400 of measuring tilt or roll of an antenna monitoring device based on the principles disclosed herein. The method 400 may be used for correcting errors in measurements of a first sensor by using measurements from a second sensor. It should be understood that steps of the method 400 shown in FIG. 4 and described herein are merely examples and should not be considered limiting. Methods with additional, alternate, or fewer number of steps should be considered within the scope of this disclosure. Although the method 400 has been described in terms of first and second sensors for the sake of brevity, the embodiments are equally applicable to multiple sets of sensors. The method 400 may be performed by a processor (e.g., processor 204 shown in FIG. 2).

The method 400 begins at step 402, where readings from a first sensor prone to first type of noise is retrieved. For example, the first sensor may comprise a MEMS sensor that may be prone to vibration, e.g., when the antenna is vibrating due to wind, vehicular traffic movement in the vicinity, etc. The tilt or roll measurement from the MEMS sensor may therefore have vibration noise as indicated by random fluctuations or jitteriness in the readings.

At step 404, readings from a second sensor not prone to the first type of noise is retrieved. For instance, the second sensor may comprise a thermal mass accelerometer that is not affected by vibration. That is, readings from the thermal mass accelerometer may be substantially free of the vibration induced noise compared to the MEMS sensor.

At step 406, it is determined whether the noisy readings from the first sensor are within a usability threshold. The usability threshold may indicate whether the noise can be reduced through downstream processing. If the noise is above the usability threshold, then the noise may be too excessive to be removed from the readings.

If it is determined that in step 406 that the noisy readings from the first sensor are within a usability threshold, step 408 may be executed to use the readings from the second sensor to correct the readings from the first sensor. For example, using signal processing techniques known in the art, readings from the second sensor may be compared against the readings from the first sensor to mitigate the noise. As another example, a higher averaging may be used on the readings from the first sensor to mitigate the noise.

If it is determined that in step 406 that the noisy readings from the first sensor are not within the usability threshold, step 410 may be executed to discard readings from the first sensor. At this point, readings from the second sensor may be used. That is, the data from the first sensor may not be used for measuring the tilt or roll and only the readings from the second sensor may be used.

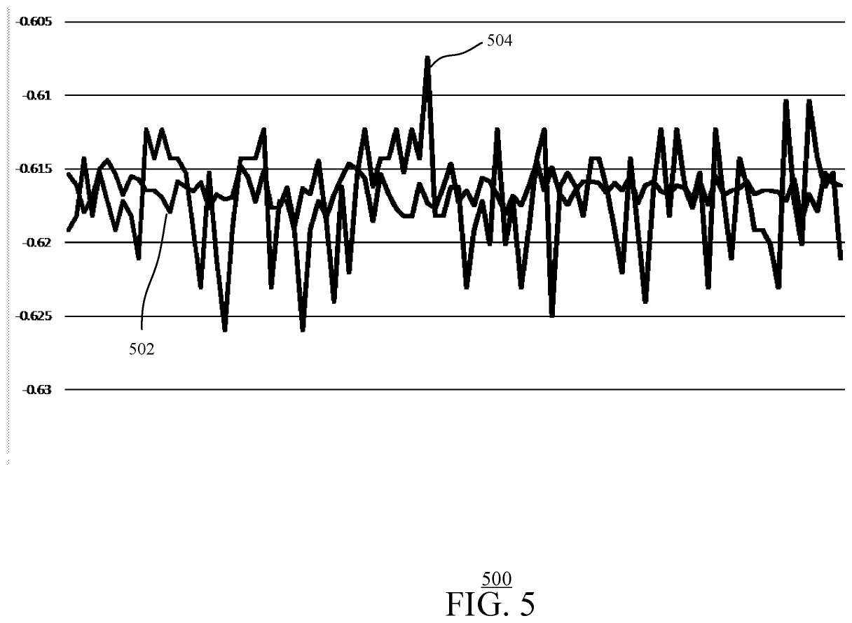

FIG. 5 shows a graph 500 illustrating an improvement in tilt and roll measurement by using multiple sensors based on the principles disclosed herein. As shown, a multiple-sensor measurement 502 is significantly stable compared to a single sensor measurement 504. The shown multiple-sensor measurement 502 in this example includes 16 sensors. The measurements may be further improved by using additional sensors and/or allowing the sensors to have additional readings. A multiplication effect—be it through augmentation or fallback, error correction, etc.—may be realized through the use of multiple sensors. Mathematically, if there are M sensors performing N readings each, the readings generate 2^((N*M−1) more information bits compared to a single sensor.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. An antenna monitoring device configured to monitor an alignment of an antenna, the antenna monitoring device comprising:
a first sensor configured to measure an antenna alignment parameter using a first type of measurement mechanism;
a second sensor configured to measure the antenna alignment parameter using a second type of measurement mechanism; and
a processor configured to determine the antenna alignment parameter based on the measurements from the first and second sensors.

2. The antenna monitoring device of claim 1, the first sensor comprising at least one of a micro electromechanical system (MEMS) sensor, an electrolytic tilt sensor, or a thermal mass accelerometer.

3. The antenna monitoring device of claim 1, the second sensor comprising at least one of a micro electromechanical system (MEMS) sensor, an electrolytic tilt sensor, or a thermal mass accelerometer.

4. The antenna monitoring device of claim 1, the antenna alignment parameter comprising a tilt of the antenna.

5. The antenna monitoring device of claim 1, the antenna alignment parameter comprising a roll of the antenna.

6. The antenna monitoring device of claim 1, the processor being configured to determine the antenna alignment parameter by:
using the antenna alignment parameter measured by the second sensor responsive to determining that the first sensor has exceeded its measurement range limitation.

7. The antenna monitoring device of claim 1, the processor being configured to determine the antenna alignment parameter by:
using the antenna alignment parameter measured by the second sensor to validate the antenna alignment parameter measured by the first sensor responsive to determining that the first sensor has exceeded its measurement range limitation.

8. The antenna monitoring device of claim 1, the processor being configured to determine the antenna alignment parameter by:
using the antenna alignment parameter measured by the second sensor to error correct the antenna alignment parameter measured by the first sensor.

9. The antenna monitoring device of claim 1, the processor being configured to determine the antenna alignment parameter by:
discarding the antenna alignment parameter measured by the first sensor; and
using the antenna alignment parameter measured by the second sensor.

10. The antenna monitoring device of claim 1, further comprising:
a first set of sensors including the first sensor, each sensor in the first set of sensors configured to measure the antenna alignment parameter using the first type of measurement mechanism;
a second set of sensors including the second sensor, each sensor in the second set of sensors configured to measure the antenna alignment parameter using the second type of measurement mechanism; and
the processor being configured to determine the antenna alignment parameter based on the measurements from the first set of sensors and the second set of sensors.

11. A method of monitoring an alignment of an antenna, the method comprising:
measuring, by a first sensor of an antenna monitoring device, an antenna alignment parameter using a first type of measurement mechanism;
measuring, by a second sensor of the antenna monitoring device, the antenna alignment parameter using a second type of measurement mechanism; and
determining, by a processor of the antenna monitoring device, the antenna alignment parameter based on the measurements from the first and second sensors.

12. The method of claim 11, the first sensor comprising at least one of a micro electromechanical system (MEMS) sensor, an electrolytic tilt sensor, or a thermal mass accelerometer.

13. The method of claim 11, the second sensor comprising at least one of a micro electromechanical system (MEMS) sensor, an electrolytic tilt sensor, or a thermal mass accelerometer.

14. The method of claim 11, the antenna alignment parameter comprising a tilt of the antenna.

15. The method of claim 11, the antenna alignment parameter comprising a roll of the antenna.

16. The method of claim 11, the determining by the processor further comprising:
using, by the processor, the antenna alignment parameter measured by the second sensor responsive to determining that the first sensor has exceeded its measurement range limitation.

17. The method of claim 11, the determining by the processor further comprising:
using, by the processor, the antenna alignment parameter measured by the second sensor to validate the antenna alignment parameter measured by the first sensor responsive to determining that the first sensor has exceeded its measurement range limitation.

18. The method of claim 11, the determining by the processor further comprising:
using, by the processor, the antenna alignment parameter measured by the second sensor to error correct the antenna alignment parameter measured by the first sensor.

19. The method of claim 11, the determining by the processor further comprising:
discarding the antenna alignment parameter measured by the first sensor; and
using the antenna alignment parameter measured by the second sensor.

20. The method of claim 11, further comprising:
measuring, by a first set of sensors including the first sensor, the antenna alignment parameter using the first type of measurement mechanism;
measuring, by a second set of sensors including the second sensor, the antenna alignment parameter using the second type of measurement mechanism; and
determining, by the processor, the antenna alignment parameter based on the measurements from the first set of sensors and the second set of sensors.
